(19) United States
(12) Patent Application Publication
(10) Pub. No.: US 2016/0143456 A1
(43) Pub. Date: May 26, 2016

(54) DISPLAY SYSTEM FOR BULK FOOD ITEMS AND RELATED METHODS

(71) Applicant: Wowthyguest, Inc., Feasterville, PA (US)

(72) Inventors: Maxim Sirotovsky, Feasterville, PA (US); Pavel R. Yanbekov, Feasterville, PA (US)

(21) Appl. No.: 14/554,024

(22) Filed: Nov. 25, 2014

(51) Int. Cl. A47F 5/10; G06Q 99/00; G06Q 20/10; A47F 5/00; A47F 7/00

(52) U.S. Cl. CPC A47F 5/108; A47F 5/0025; A47F 7/0071; G06Q 20/10; G06Q 99/00

(57) ABSTRACT

A system displaying bulk food items for sale in a public establishment includes a plurality of display units configured to be positioned on a support surface at the public establishment such that the plurality of display units are aligned along a plane that is parallel to the support surface. Each unit including a bottom supportable by the support surface, a top spaced from the bottom, and a side that extends between the top and the bottom. The system includes a plurality of containers supported by the top of at least one of the plurality of display units. Each container is configured to hold bulk food items and includes an access opening sized to permit removal of the bulk food items from the container.

### TECHNICAL FIELD

The present disclosure relates to a display system for bulk food items and related methods.

### BACKGROUND

Food items such as nuts, grains, candies, and the like are sometimes sold in bulk. Typical display systems for such bulk food items include containers with dispensers configured to allow a consumer to remove a preselected amount of the bulk food. The containers are often placed in vertically stacked array. Such stacked-type displays should provide easy access to the dispensers by a person standing on the ground in front of the containers. But, it is not always the case because several of these containers are positioned at or above eye-level of an average sized adult and can be difficult to reach. Stacked systems also minimize surface area required to display products. For instance, candy retailers may install stacked systems around the interior walls opening up usable floor space for consumer traffic management and other types of merchandise displays.

### SUMMARY

An embodiment of the present disclosure is a system for displaying bulk food items for sale in a public establishment. The system includes a plurality of display units configured to be positioned on a support surface at the public establishment such that the plurality of display units are aligned along a plane that is parallel to the support surface. Each unit includes a bottom supportable by the support surface, a top spaced from the bottom, and a side that extends between the top and the bottom. A plurality of containers supported by the top of at least one of the plurality of display units, each container configured to hold bulk food items. The container includes an opening sized to permit removal of the bulk food items from the container.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 is a top perspective view of a display system for bulk food items according to an embodiment of the present disclosure;

FIG. 2 is a plan view of the display system shown in FIG. 1, illustrating the display system in a thoroughfare of a public establishment;

FIG. 3A is a top view of a display unit of the display system shown in FIG. 1;

FIG. 3B is a cross-section view of a portion of display unit taken along line 3B-3B in FIG. 3A;

FIG. 4 is a side view of the display unit shown in FIG. 5;

FIG. 5 is a plan view of the display system shown in FIG. 1;

FIG. 6 is an elevation view of the display system shown in FIG. 1;

FIGS. 7A and 7B are perspective and top plan views, respectively, of a display system for bulk food items according to another embodiment of the present disclosure;

FIGS. 8A and 8B are perspective and top plan views, respectively, of a display system for bulk food items according to another embodiment of the present disclosure;

FIGS. 9A and 9B are perspective and top plan views, respectively, of a display system for bulk food items according to another embodiment of the present disclosure;

FIGS. 10A and 10B are perspective and top plan views, respectively, of a display system for bulk food items according to another embodiment of the present disclosure;

FIGS. 11A and 11B are perspective and top plan views, respectively, of a display system for bulk food items according to another embodiment of the present disclosure; and

FIGS. 12A and 12B are perspective and top plan views, respectively, of a display system for bulk food items according to another embodiment of the present disclosure.

### DETAILED DESCRIPTION OF ILLUSTRATIVE EMBODIMENTS

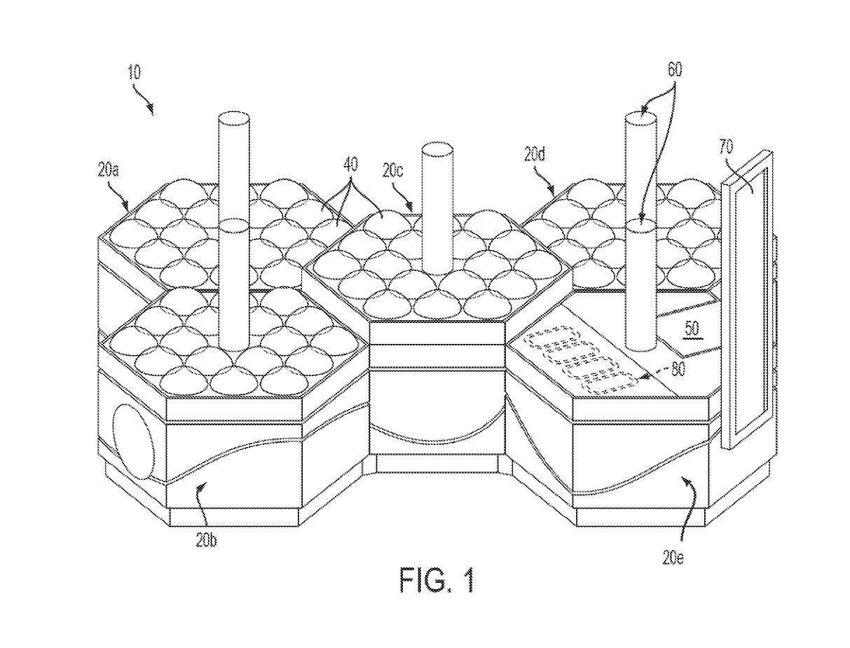

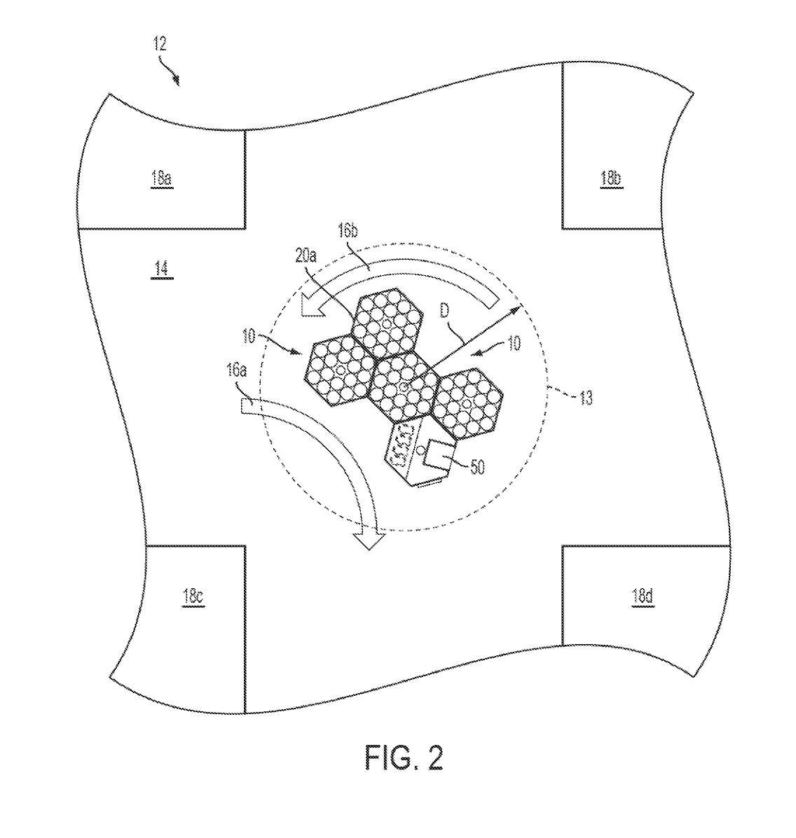

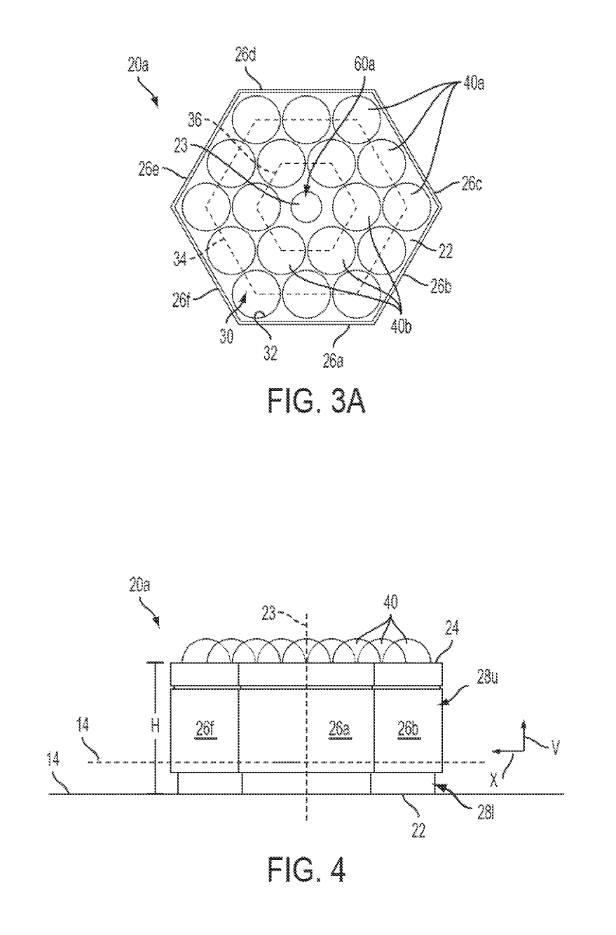

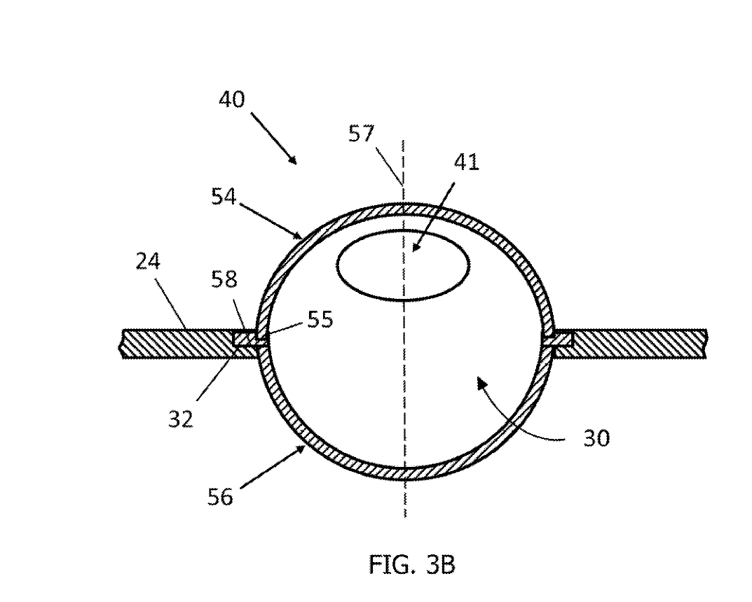

Referring to FIGS. 1 and 2, an embodiment of the present disclosure is system 10 is configured to hold and display bulk food items for sale in a public establishment 12. The system 10 is designed to present to and allow consumers to purchase bulk food items. The system 10 includes a plurality of display units 20a, 20b, . . . 20e that can be positioned on a support surface 14 at the public establishment 12. In some cases in this document, reference number 20 is used to refer to display units 20a, 20b, 20c, and 20d. One or more up to all of the plurality of display units 20a, 20b, 20c . . . 20e, include a plurality of containers 40. Each container 40 is configured to hold bulk food items, such as: candies, chocolates, nuts, grains, or any other type of bulk food item. The display units 20 are configured to display the varied bulk food items held in the containers. Each container 40 also includes an access opening 41 (FIG. 3B) that is sized to permit removal of the bulk food items from the container 40.

The plurality of display units 20a-20e are configured to 1) impart modularity into the system 10 for easy assembly and disassembly at the public establishment 12, and 2) maximize observance and access to the bulk food items on display in the containers 40 when the system is assembled. In most cases, system assembly takes less than about 8 hours to 10 hours so that the system 10 can be assembled and product offerings placed in the containers 40 when the public establishment is closed and be ready for consumers at the next opening time. Disassembly is also relatively quick taking less than about 8 hours to 10 hours in most cases. Further, because the system 10 is modular, the display units 20a-20e can be easily moved around to different locations within the public establishment. This feature is advantageous because the exact location of the system 10 can be adjusted to attract more consumers to purchase the bulk food items based on observed foot traffic. Further, when the system 10 is assembled and arranged on the support surface 14, an average height adult can observe most, if not all of the containers 40, when approaching or standing near the system 10.

The system 10 can include several auxiliary components in addition to the containers 40. For instance, the system includes a point-of-sale (POS) system 50 and optionally one or more of a lighting assembly 60, a sign 70, and cleaning system 80. The POS system 50 can be any type of electronic devices or register for receiving and recording. payments received for the bulk food items selected by the consumer. For instance, the POS system 50 can include a computing device, such as a smartphone or tablet, with an attachment module for receiving electronic credit or debit card payments. A scale (not shown) can be used to determine the bulk weight of bulk food items removed from one or more of the containers 40 by a consumer. The POS system 50 can be configured to receive and record payments based on inputs received from a sales associate. In some cases, the scale can be electronically connected to the computing device used to record the weight of the bulk food items. The computing device can then generate the amount of payment required. The POS system 50 can be configured for electronic communication with various payment-processing entities, e.g. VISA, MASTERCARD, AMERICAN EXPRESS, DISCOVER, PAYPAL, and/or gift cards associated with any of these aforementioned entities. Additional hardware devices, such as scanner or readers, can be used to detect and read bar code or quick response (QR) code presented by a user interface of a consumer's smartphone device. It should be appreciated that the bulk food items can be sold on a volume basis. If the bulk food items are sold on a volume basis, the POS system 50 can be configured to record and receive payment on a volume basis according to predetermined price schedule making transactions quick and simple. Lighting assemblies 60 and signs 70 can be used to highlight bulk food items and convey marketing information, such as branding and pricing information. The optional cleaning system 80 may be required depending on the policy of the public establishment and local health code regulations. Such cleaning systems can include a sink or other container for holding water and or cleaning compositions and towels for hand cleaning. The cleaning system can include a four bay sink designated for wash, rinse, sanitize, with the fourth sink used for hand washing.

Continuing now with FIG. 2, the system 10 is configured for use in the public establishment 12. A public establishment 12 can be any establishment where the general population is invited, such as a retail shopping mall, outdoor shopping mall, airport, museum, movie theater, concert venue, sport venue or similar establishment. In accordance with the illustrated embodiment, the public establishment 12 is a retail shopping mall that includes multiple retail locations 18a, 18b, 18c, and 18d located where walkways 19a and 19b intersect. The system 10 can be assembled on the surface 14 along or near one or more pedestrian thoroughfares 16a and 16c of the public establishment 12 to attract pedestrians to the display of bulk food items held in the containers 40. A pedestrian thoroughfare 16a and 16b is a heavily traveled path along the support surface 14 that pedestrians typically walk along in a public establishment. In particular, the system 10 can be assembled along the support surface 14 within an area 13 that encompasses or is adjacent to pedestrian thoroughfares 16a and 16b by a predetermined distance D. The distance D can be measured from a center (not numbered) of any display unit 20a-20e outwardly to a location of a thoroughfare. As shown in FIG. 2, the distance D extends from a center (not numbered in FIG. 2) of a centrally disposed display unit 20e to a location spaced outwardly from the system 10 toward the thoroughfares 16a and 16b. The distance D can vary depending on the layout of the public establishment 12, arrangement of walkways 19a and 19b, location of type of retailers near the system 10. In some embodiments, the distance D can be up to about 15 feet. In still other embodiments, the distance D can be greater than 15 feet. As noted above the exact location of the system 10 on the support surface 14 can be changed as need until the distance D is appropriate so as to attract pedestrians walking along the thoroughfares 16a and 16b and entice them to select and purchase bulk food items.

Continuing with FIG. 2, the plurality of display units 20 are configured to be disposed in close proximity with one another along the support surface 14. In accordance with the illustrated embodiment, the plurality of display units 20 may include a first display unit 20a, a second unit 20b, a third unit 20c, a fourth unit 20d, and a fifth unit 20e. One or more up to all of the display units are configured to support multiple containers 40 while one or more of the display units 20 is configured to support the POS system 50 and optional cleaning system 80. As illustrated, display units 20a, 20b, 20c, and 20d are configured as display units with each one carrying multiple containers 40. Unit 20e is configured as an auxiliary display unit that includes the POS system 50 and cleaning system 80.

Turning to FIGS. 3 and 4, the display units 20 are configured to be disposed in close proximity with one another along a horizontal direction X on the support surface 14. One display unit 20a is illustrated in FIGS. 3 and 4 and is describe below although each display unit 20b through 20e can be constructed similar to display unit 20a. Display unit 20a includes a bottom 22 supportable by the support surface 14, a top 24 spaced from the bottom 22 along a vertical axis 23 that extends along a vertical direction V that is angularly offset with respect to the horizontal direction X, and a side 26 that extends between the bottom 22 and the top 24. It can also be said that the unit 20a has a lower portion 28l disposed toward the bottom 22 and an upper portion 28u disposed toward the top 24 and a spaced from the lower portion 28l along the vertical axis 23. The lower and upper portions 28l and 28u are thus defined below and above, respectively, a middle region (not shown) located equidistant from both the bottom 22 and top 24. The unit 20a is disposed on the support surface 14 along a plane P that extends through the lower portion 28l of the unit. While illustrated embodiment of the display unit 20a has a bottom 22 configured for a flat support surface 14, in other embodiment, the bottom 24 can inclined so that when it is placed on an inclined support surface 14, the top 24 is level. Conversely, the bottom 22 can be flat and the top 24 can be inclined with respect to the bottom 22 such that when the display unit 20a is placed on the inclined support surface 14, the top 24 is generally level. In still other embodiment, the bottom 22 can include a plurality of legs or supports that contact the support surface 14.

Returning to FIGS. 3 and 4, the side 26 of unit 20a can have one up to a plurality of side portions that define a cross-sectional shape of the display unit 20a. The cross-sectional shape can have at least one of a linear component and a curvilinear component. In accordance with the illustrated embodiment, the display unit 20a has a side 26 with six side portions 26a through 26f that define a hexagonal cross-sectional shape that is perpendicular to the vertical axis 23. Thus, the cross-sectional shape of the display unit 20a can be said to have primarily linear components. As will be further detailed below, the display units can have wide range of cross-sectional shapes.

Continuing with FIGS. 3 and 4, the display unit 20a is configured to support the containers 40 at a height above the support surface 14 that is convenient for observance and access by consumers with a range of statures: from the average height adult to relatively younger children. The display unit 20a defines a display unit height H that extends from the bottom 22 to the top 24 along the vertical axis 23. The unit height H can range between about 10 inches and about 45 inches. In one particular embodiment, at least one of the display units 20a through 20e has a height H between about 32 inches and 38 inches. Each display unit 20a through 20e can have similar or the same heights H. Alternatively, the display unit height H can vary among a subset of or all of the display units 20a-20e as further detailed below.

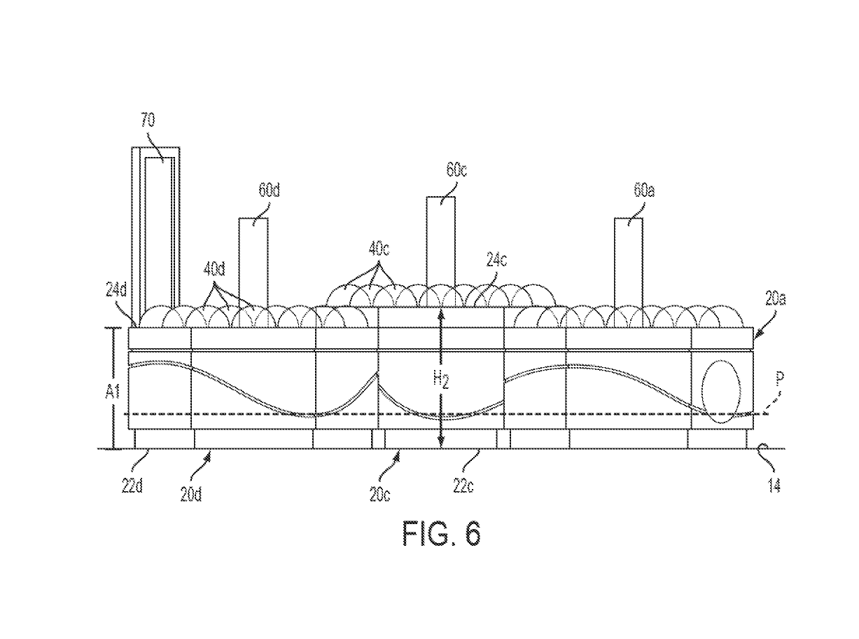

Turning briefly to FIG. 6, in accordance with the illustrated embodiment, each display unit 20a-20e is disposed in relation to each other along the plane P that is parallel to the support surface 14 and extends through the lower portion 28l of the units 20a-20e. As noted above, the vertical direction V is angularly offset with respect to the horizontal direction X. The vertical axis 23 of each unit 20a-20e is angularly offset with respect to the plane P. Only the vertical axis 23 of unit 20c is shown in FIG. 6 for ease of illustration. As noted above, the bottom 22 of each unit can be shaped to account for any angle or slope in the support surface 14. In the case where the support surface 14 is flat (FIGS. 4 and 6), the vertical axis 23 would be perpendicular to the support surface 14 and the plane P. In the case where the portion of the support surface 14 that the display unit 20a sits upon is inclined, the vertical axis 23 will be angularly offset with respect to the plane P but not perpendicular to the plane P or the support surface 14.

Continuing with FIGS. 3 and 4, the display unit 20a is configured to support multiple containers 40. The top 24 of display unit 20a include a plurality of openings 30 that are sized to receive the respective plurality of containers 40. The top 24 define respective edge 32 32 of the openings 30. The edges 32 can support the container 40 as will be further detailed below. Further, the plurality of openings 30 are aligned in multiple rows such that when the containers 40 are disposed in the respective openings 30, the containers 40 are disposed along multiple rows. As illustrated, a first set of containers 40a can be aligned along a row that extends along line 34 about vertical axis 23. A second set of containers 40a can be aligned along a row that extends along line 36 between the line 34 and the vertical axis 23. In a particular embodiment, a person standing on the support surface 14 near any one of the plurality of display units 20a-20e would not have reach over more than two rows of containers 40 to access a selected container holding the bulk food item, depending on the size of the containers 40,

Turning to FIG. 3B, each container 40 has construction configured to hold and display bulk container stored therein. one or more of the plurality of containers 40 can be transparent. Each container 40 can include base 56 and a cover 54 spaced from the base 56 along a central axis 57. The cover 56 has a lower or outer edge 55 and an opening 41 through which a consumer can reach through and select the bulk food item. In accordance with the illustrated embodiment, the cover 56 is curved with respect to the central axis 57 to define a hemispherical dome shape. The base 56 has an upper or outer edge 58 and is curved with respect to the central axis 57. The base can 56 define a hemispherical dome shape. In accordance with the illustrated embodiment, one or more up to all of the containers 40 have a cover 56 with a curved profile. The base 56 is sized to fit within the opening 30 such that the base outer edge 58 is supported by the edge 32 of the unit top 24. The bottom edge 55 of the cover 54 sits upon outer edge 58 of the base 56. Thus, the cover 54 extends upwardly from the unit top 24 and the base 56 can extend into an interior volume of the unit 20a. As noted above, the cover 54 and base 56 are shown with curved, dome shapes. In alternate embodiments, the base 56 can have a flat, planar structure supported by the edges 32 of the unit top 24. The container 40 has dimension C that is perpendicular to the central axis 57 and extends between opposing points (not shown) of the respective bottom edges 55 and 58 of container components. The dimension C can range between about 10 inches to about 18 inches. In most cases, the dimension C is about 12 inches

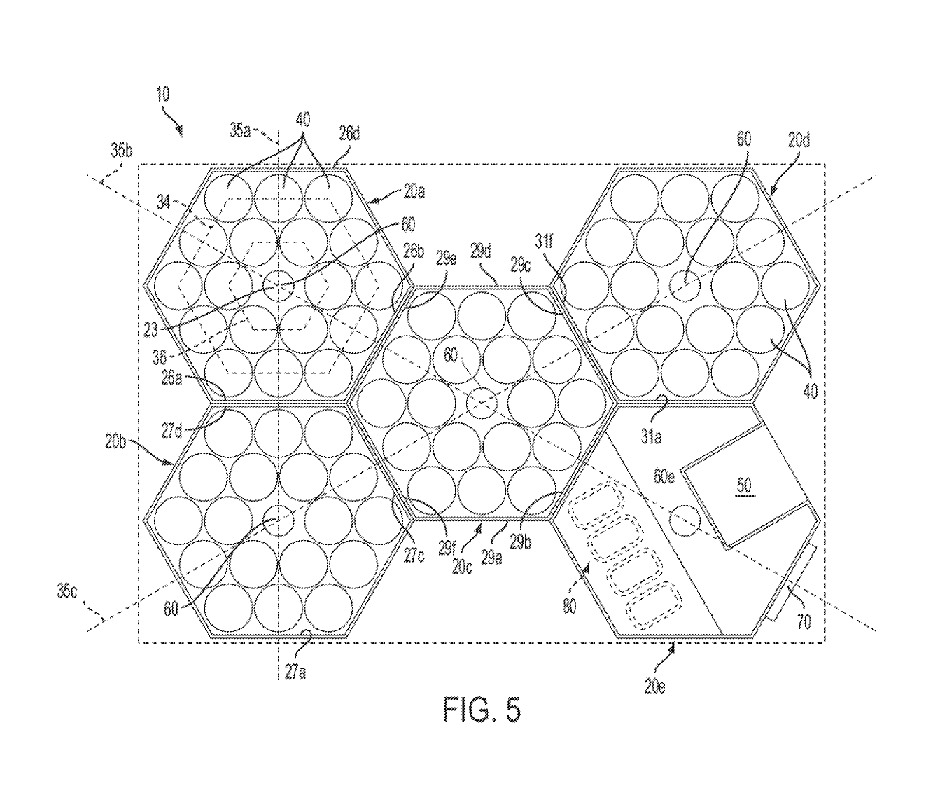

Turning now to FIG. 5, the display units 20a through 20d are arranged in close proximity to one another. In accordance with illustrated embodiment, each one of the display units 20-20e can be arranged to be close to or abutting two other display units. In accordance with the illustrated embodiment, a pair of the display units 20a and 20b can be arranged in close proximity to each other along a first axis 35a. A second pair of display units 20a and 20c can be arranged in close proximity to each other along a second axis 35b that intersects, and is angularly offset with respect to, the first axis 35a. A third pair of display units 20b and 20c can be arranged in close proximity to each other along a third axis 35c that intersects and is angularly offset with respect to the first and second axes 35a and 35b. Thus, the first display unit 20a is close to or abuts the second and third display units 20b and 20c. The second display unit 20b is close to or abuts the first and third display units 20a and 20c. The third or centrally display unit 20c is close to or abuts each one of the other display units 20a, 20b, 20d, and 20e. More specifically, the first side portion 26a of display unit 20a abuts side portion 27c of unit 20b and side portion 26b of display unit 20a abuts side portion 29e of display unit 20c. Moreover, side portions 29e and 29f of display unit 20c abuts display units 20a and 20b, respectively. This arrangement minimizes the footprint of the system 10 and provides easy access to the containers regardless of where the consumer is standing around the perimeter of the system 10. Thus, a person standing in area proximate to where display units 20a and 20c adjoin will have access to multiple rows of containers 40 in both display units 20a and 20c. Further, adjacent display units, for instance, the first pair of display units 20a and 20b can be connected to each other using various connectors, such as bolts, latches, or other mechanisms that can be unlocked to allow the display units to be separated from one another. Adjacent pairs of display units are shown in an abutting relationship. It should be appreciated that adjacent pairs of display units can be positioned in proximity to but not in contact with each other. Thus, adjacent display units can be spaced apart from each other define a gap (not shown) therebetween.

Continuing with reference to FIG. 5, the system 10 has a modular design that covers a relatively small surface area of the support surface 14. The system 10 can be assembled within a surface area defined by an outermost perimeter 48 that encloses the system 10. The outermost perimeter 48 can define the maximum required surface area on the support surface 14 that contains the system. The actual footprint of the system 10 can be the actual surface of the support surface 14 covered by the display units 20. Thus, when the plurality of display units 20 are positioned on the support surface 14, the system 10 has a maximum required surface area up to about 500 square feet. However, the actual foot print of the system 10 can be less than 500 square feet. For instance, the actual footprint can be between about 50 square feet and about 450 square feet of the support surface, depending on system design and number of display units 20 used.

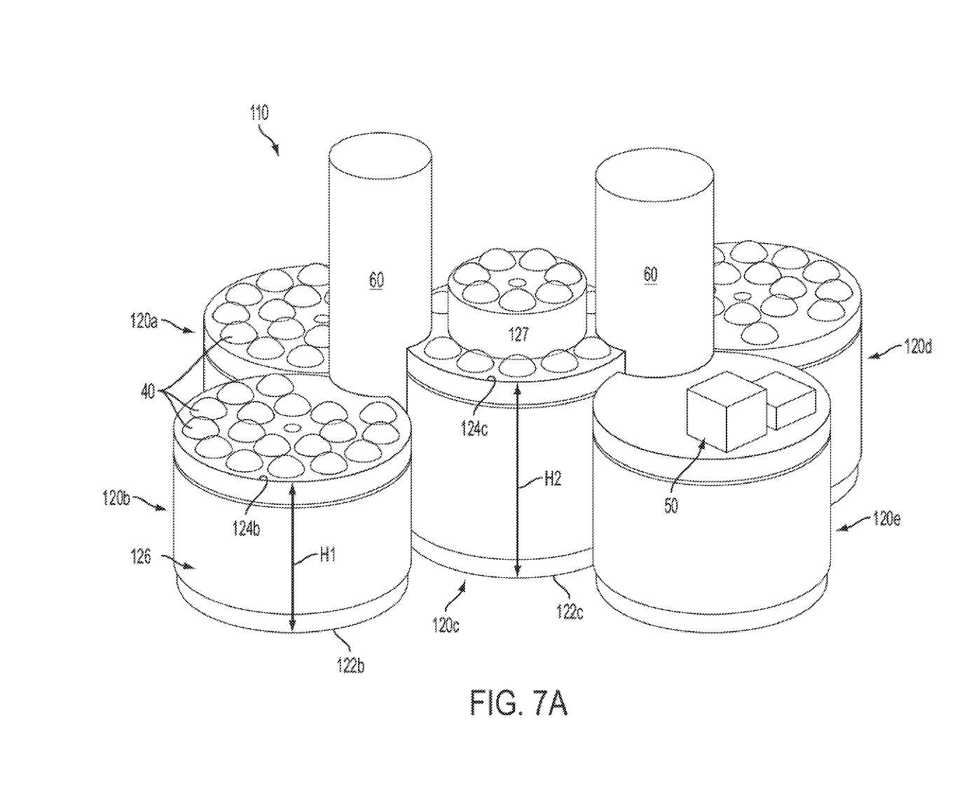

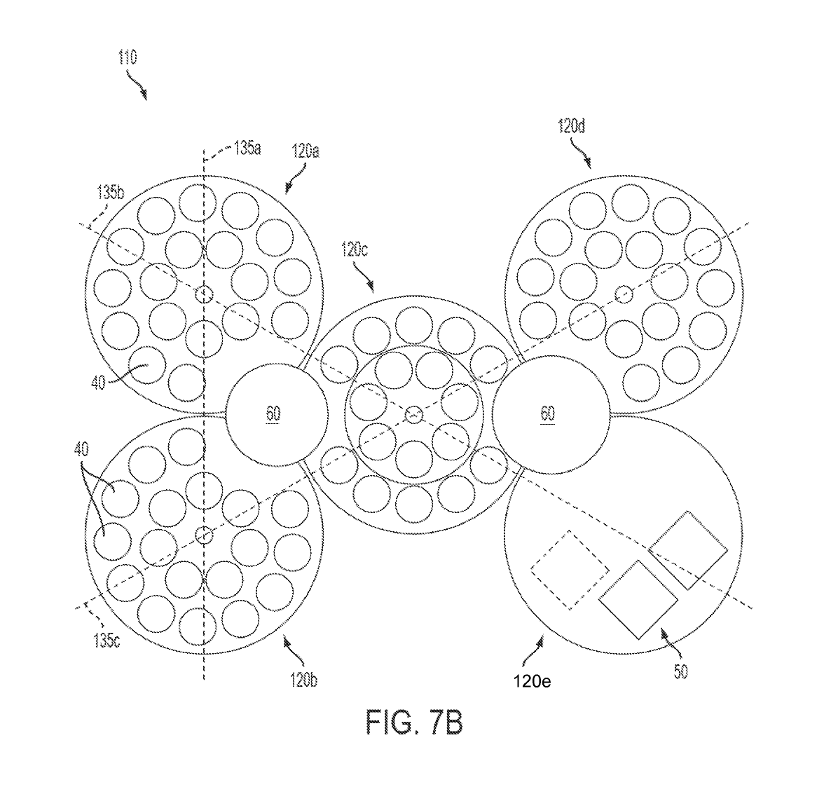

Turing to FIG. 6, the system 10 is configured to display the containers at varying elevations above the support surface 14 although each display unit 20 is aligned along a plane P that is parallel to the support surface 14. This is accomplished by utilizing display units 20a with 20e with differing heights. For instance, display units 20a and 20d define a first height H1 and the centrally disposed display unit 20c defines a second height H2 that is greater than H1. Accordingly, one up to several of the display units can have a height that is greater than one up to several of the other display units. In accordance with an alternative embodiment, the display units 20a through 20d can include additional support frames (not shown) for elevating containers above the top 24 of the display units 20. See for example, element 127 in FIG. 7A.

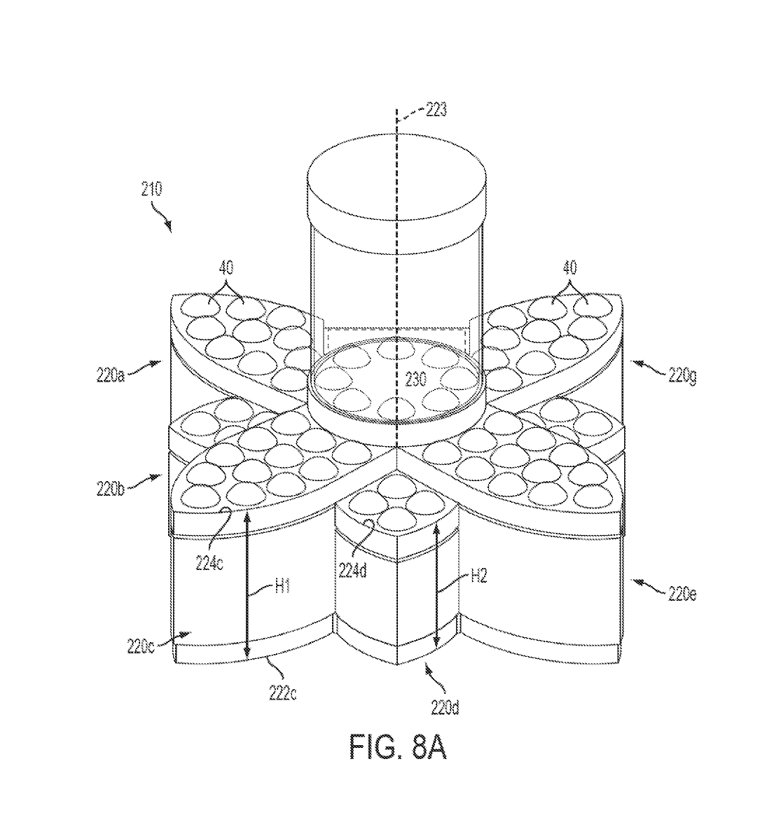

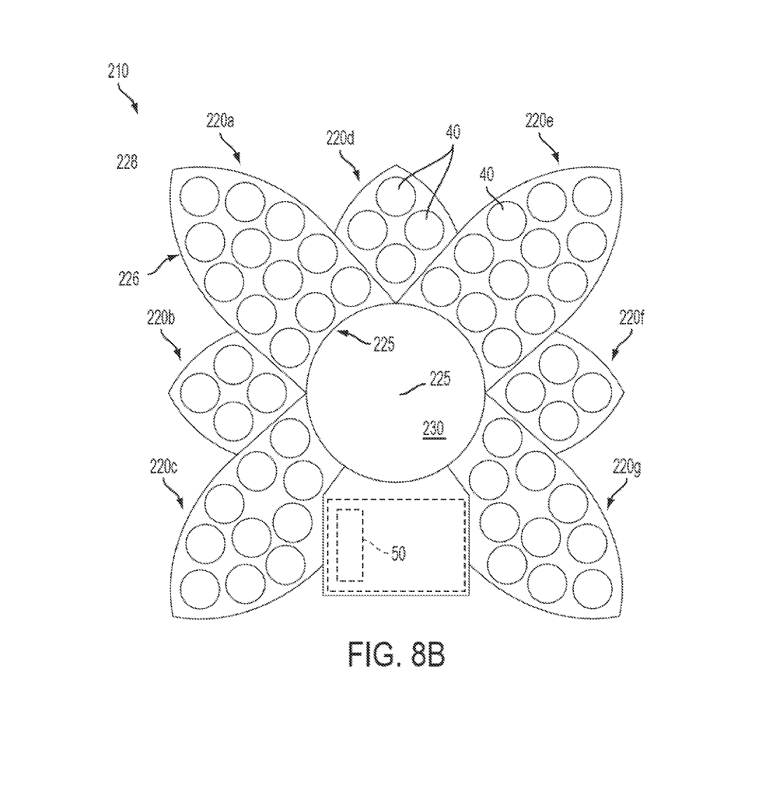

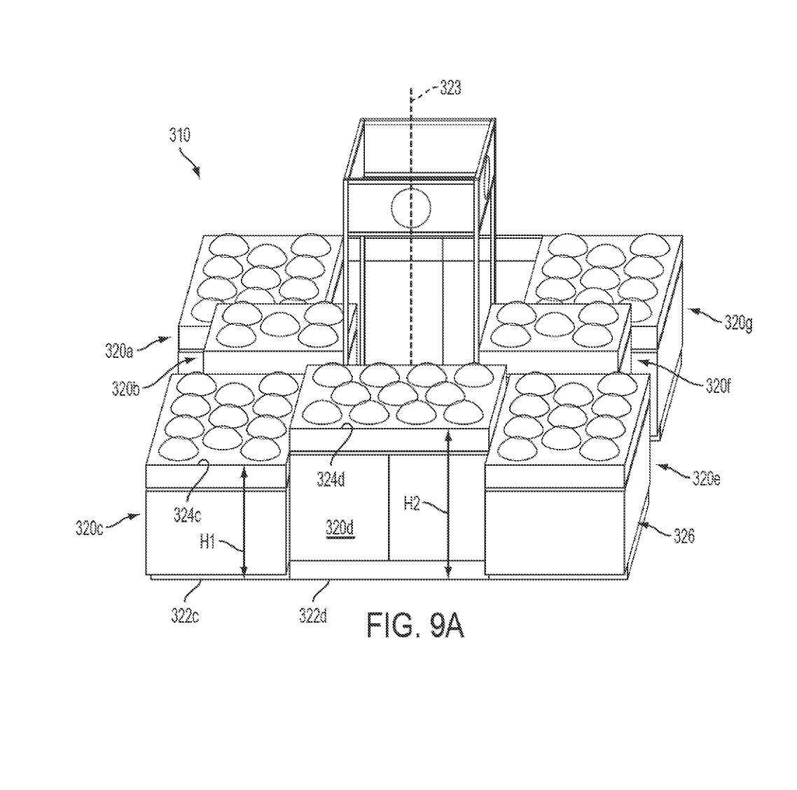

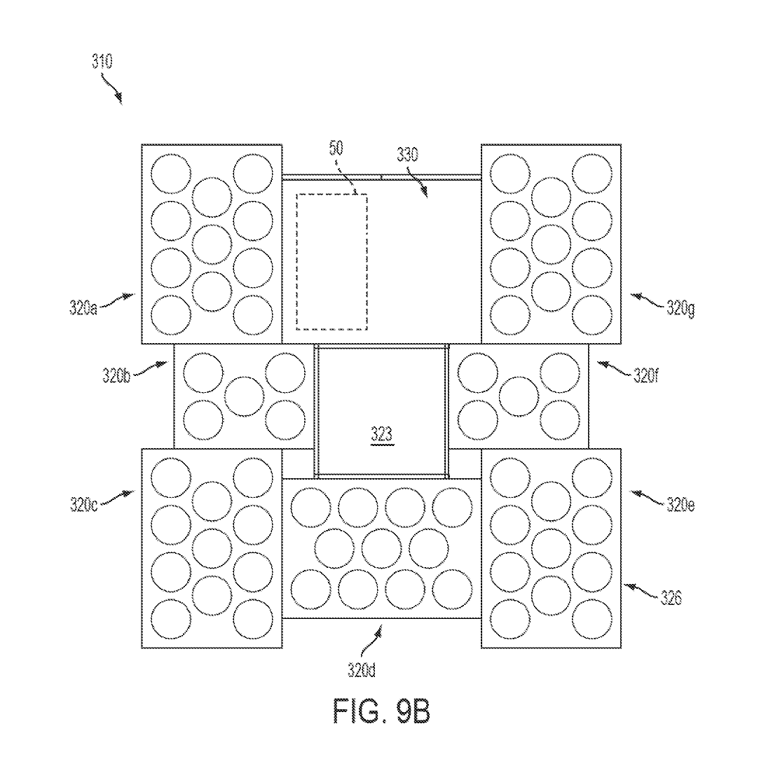

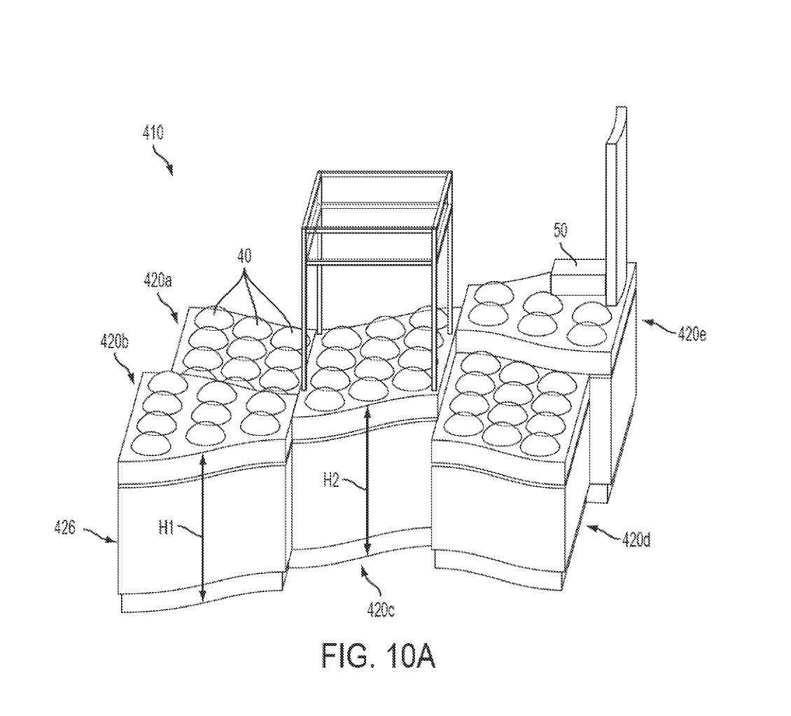

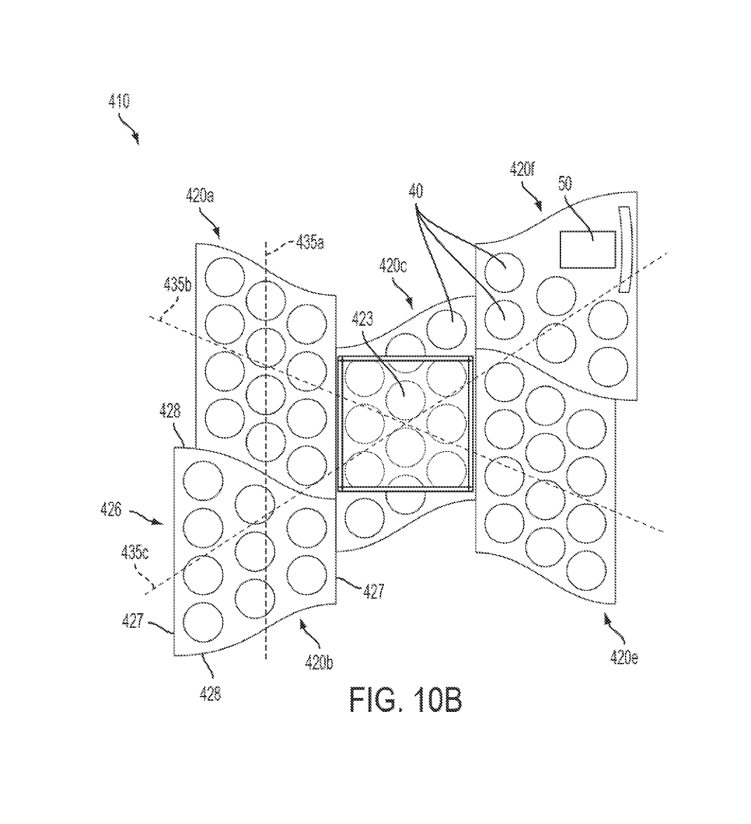

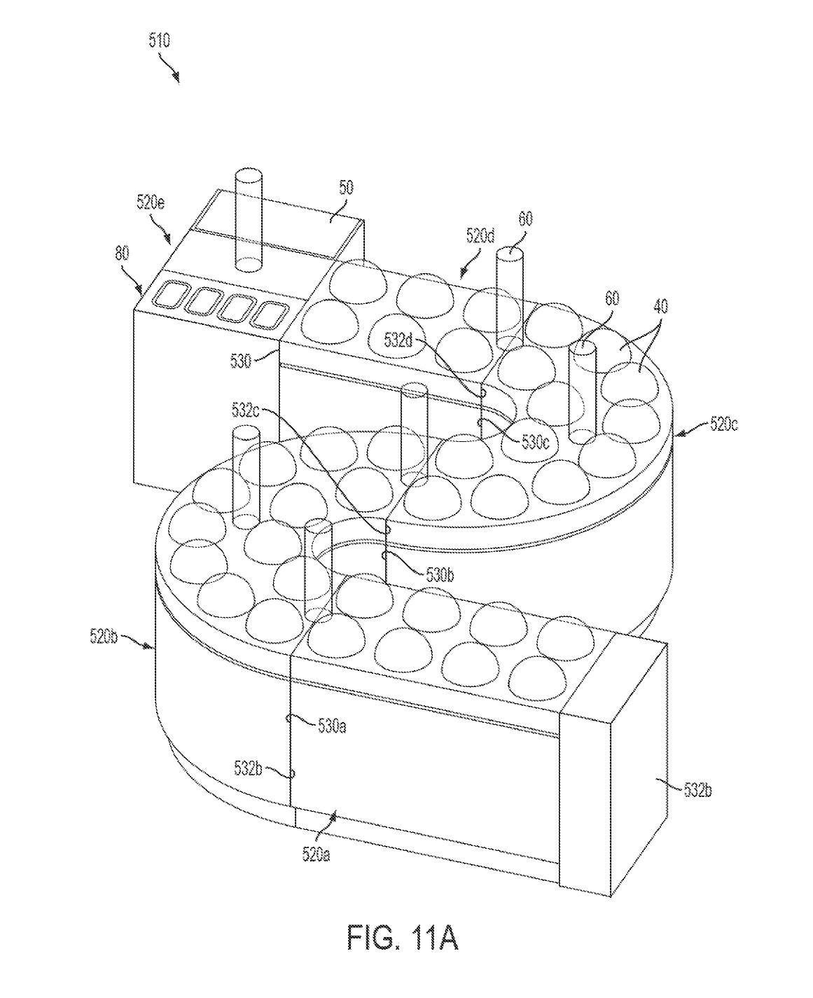

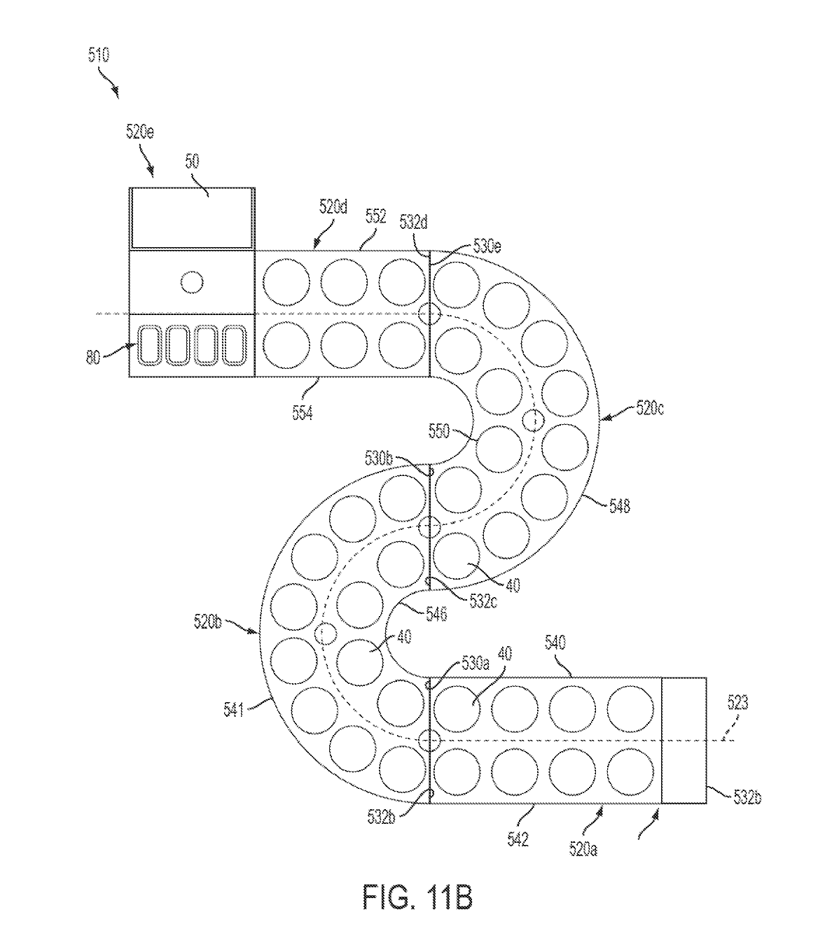

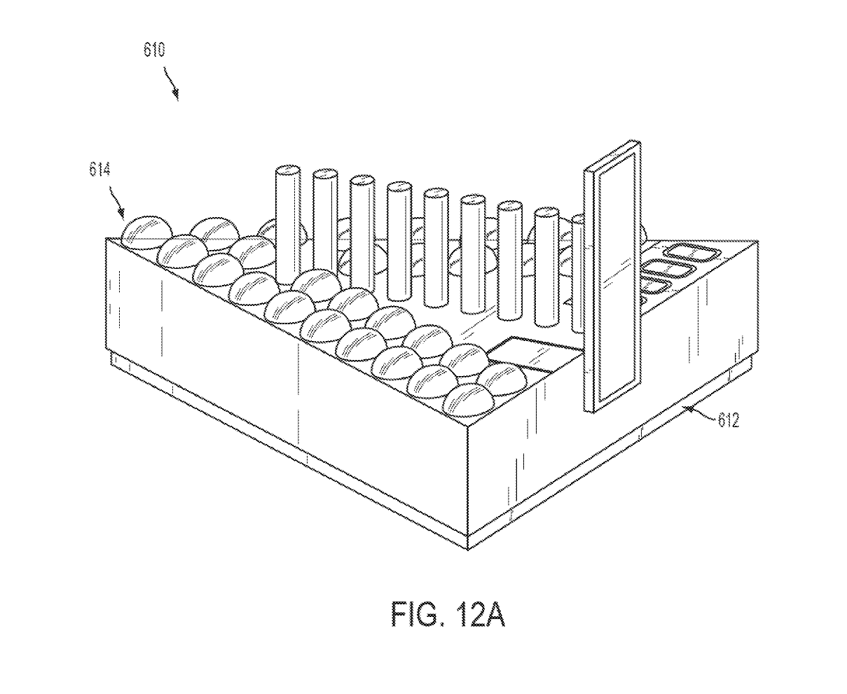

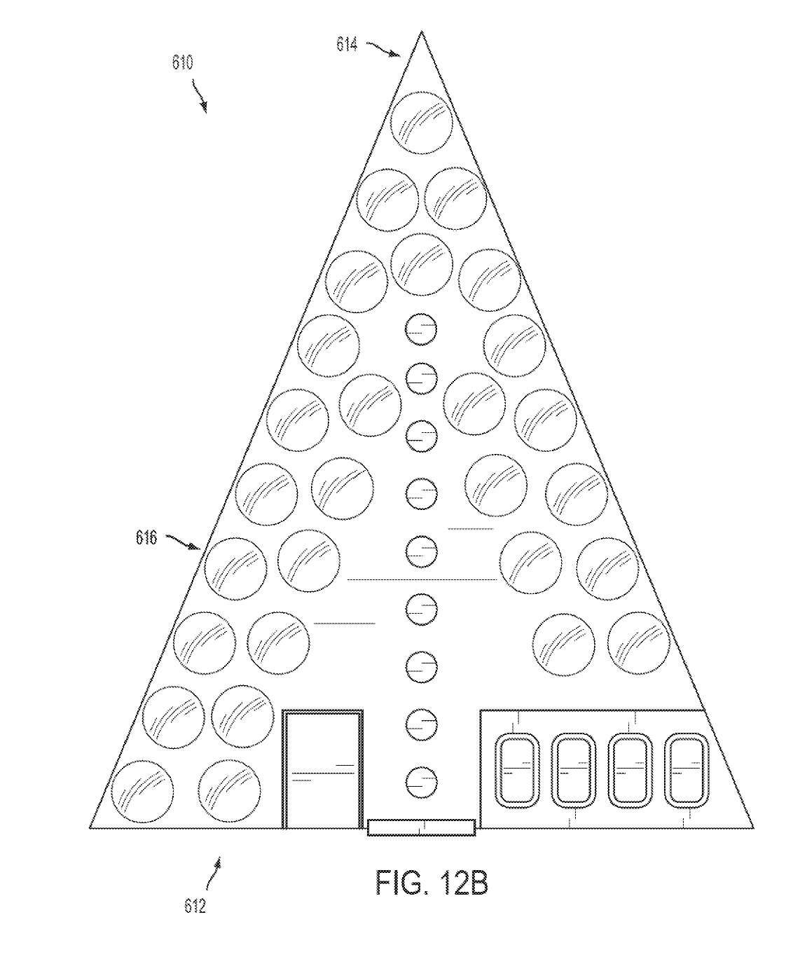

FIGS. 7A-12B illustrate embodiments for a system with display units having alternative cross-sectional shapes and thus differing footprints along the surface 14 of the public establishment. As noted above, each unit of the system can have a cross-sectional shape with at least one of a linear component and a curvilinear component. For example, in some embodiments, the display unit has cross-sectional shapes with primarily linear components that define a hexagonal cross-sectional shape (FIGS. 1-6), a rectilinear cross-sectional shape (FIGS. 9A and 9B), or a triangular cross-sectional shapes (FIGS. 12A and 12B). In other embodiments, the display units can have a cross-sectional shape with a curvilinear component. For instance, the cross-sectional shape can circular (FIGS. 7A and 7B), or curved and elongate (FIGS. 8A and 8B). In addition, certain other embodiments can have a cross-sectional shape with both linear and curvilinear components. In particular, one up to all of the display units can have both linear and curvilinear sides as shown in FIGS. 10A and 10B, or one or more of display units can have linear or curvilinear sides, as shown in FIGS. 11A and 11B.

As noted above, FIGS. 7A-12B illustrate alternative embodiments for a system configured to display bulk food items. For the purposes of brevity and ease of illustration, similar element numbers will be used to identify elements common between the system 10 illustrated in FIGS. 1-6 and the systems 110, 210, 310, 410, and 510 illustrated in FIGS. 7A-12B. Each system 10, 110, 210, 310, 410, and 510 includes a plurality of display units that hold multiple containers 40 within respective openings 30 of the unit. Each system includes a display unit with a bottom 22, a top 24, and a side that extends from the bottom 22 to the top 24. For ease of illustration, element numbers for the top and bottom of each unit include letter “a”, “b”, “c”, etc., associated with a particular unit. For example, unit 120a shown in FIG. 7B has a bottom 22a and top 24a, unit 220a has a bottom 22a and top 24a, even though the display units have different shapes. Further, each of the system described below and illustrated in FIGS. 7A-12B may have a POS system 50 and optional lighting assemblies 60, signs 70, and cleaning system 80.

Turning to FIGS. 7A and 7B, in accordance with an alternative embodiment of the present disclosure, the system 110 includes a plurality of display units 120a, 120b, 120c . . . 120e that can be positioned on a support surface 14 at the public establishment 12. One unit 120e includes a POS system 50. Each unit 120a, 120b, 120c . . . 120e includes a side 126 that has a curvilinear component and defines a circular cross-sectional shape. The display units 120a, 120b, 120c . . . 120e can be arranged so as to be adjacent to or abutting at least two other display units. For instance, a first pair of the display units 120a and 120b can be arranged in close proximity to each other along a first axis 135a. A second pair of display units 120a and 120c can be arranged in close proximity to each other along a second axis 135b that intersects, and is angularly offset with respect to, the first axis 135a. Further, a third pair of display units 120b and 120c can be arranged in close proximity to each other along a third axis 135c that intersects and is angularly offset with respect to the first and second axes 135a and 135b. Arranged in this way the first display unit 120a is close to or abuts the second and third display units 120b and 120c. Adjacent display units can be connected to each other using various connectors, such as bolts, latches or other mechanisms. Further, display unit height H can vary among two up to all of the display units 120a-120e. Alternatively, the display unit height H can be the same for each display unit. Further, one or more of the display units can additional platforms 127 that are supported by the top 24. The platforms 127 can elevate containers 40 above the top 24 of the display units.

Turning to FIGS. 8A and 8B, in accordance with an alternative embodiment of the present disclosure, the system 210 includes a plurality of display units 220a, 220b, 220c . . . 220g that can be positioned on the support surface 14 at the public establishment 12 in a radial pattern about a vertical axis 223. Each unit 220 (sometimes 220 is used interchangeably with 220a, 220b, 220c . . . 220g) includes a base 225, a unit end 228 and side 226 with curvilinear portions. The side curvilinear portions (not numbered) extend from the base 225 in a direction away from the central axis 223 and converge at the unit end 228. The display units 220a, 220b, 220c . . . 220g are arranged about central vertical axis 223 in a radial pattern such that the unit ends 228 are spaced apart from each other around the vertical axis 223 The unit base 225 can be secured to a central hub 230. Further, one or all of the units 220a through 220g are arranged in close proximity to abut at least two other display units. For instance, display unit 220a abuts display unit 220b and 220d and display unit 220b abuts display units 220a and 220c. Further, different display units 220a through 220g can have different unit heights H1 and H2. For instance, display unit 220c can have a height H1 that is greater than a height H2 of display unit 220c.

Turning to FIGS. 9A and 9B, in accordance with an alternative embodiment of the present disclosure, the system 310 includes a plurality of display units 320a, 320b, 320c . . . 320g that can be positioned on the support surface 14 at the public establishment 12 in a radial pattern about the central axis 323. Each unit 320 includes linear sides to define a rectilinear cross-sectional shape that is perpendicular to the central axis 323. Further, one or up all of the units 320a through 320g are arranged in close proximity to or abut at least two other display units. For instance, display unit 320a abuts display unit 320b and 320d. Display unit 320b abuts display unit 320a and 320c. Further, display units 320a through 320g can have different unit heights H1 and H2. For instance, display unit 320c can have a height H1 that is greater than a height H2 of display unit 320c.

Turning to FIGS. 10A and 10B, in accordance with an alternative embodiment of the present disclosure, the system 410 includes a plurality of display units 420a, 420b, 420c . . . 420e that can be positioned on the support surface 14 at the public establishment 12. Each unit 420 includes a side 426 with a pair of spaced apart linear side portions 426 and a pair of spaced apart curvilinear side portions 428. The side 426 of the units thus defines a cross-sectional shape with both linear and curvilinear components. At least one and up to all of the display units 420a through 420e are arranged in close proximity to or abut at least two other display units. For instance, a pair of the display units 420a and 420b can be arranged in close proximity to each other along a respective first axis 435a. A second pair of display units 420a and 420c can be arranged in close proximity to each other along a second axis 435b that intersects, and is angularly offset with respect to, the first axis 435a. Further, a third pair of display units 420b and 420c can be arranged in close proximity to each other along a third axis 435c that intersects and is angularly offset with respect to the first and second axes 435a and 435b. Arranged in this way the first display unit 420a is close to or abuts the second and third display units 420b and 420c. For instance, adjacent display units can be connected to each other using various connectors as noted above. Further, the display units 420a through 420e can have different unit heights. For instance, display unit 420b can have a height H1 that is greater than a height H2 of display unit 420c

Turning to FIGS. 11A and 11B, in accordance with an alternative embodiment of the present disclosure, the system 510 includes a plurality of display units 520a, 520b, 520c, 520d and 520e arranged end-to-end along a curved horizontal axis 523. The curved axis 523 can be a parallel to the support surface 14 (not shown) and extends through each one of the display units. Each display unit 520 has a first end 530, a second end 532, opposed to the first end 530 along the axis 523, a first side portion 540 and a second side portion 542 that extend between the first and second ends 530 and 532. The sides portions 540 and 542 are spaced apart from the central axis 523. In the description below, element number 530 is used interchangeably with reference numbers 530a, 530b, . . . 530e. Element number 532 is used interchangeably with reference numbers 532a, 532b, . . . 532e. Element number 540 is used interchangeably with element numbers 540a, 540b, . . . 540d, which refer to first side portions of respective display units 520a through 520d. And element number 542 is used interchangeably with reference numbers 542a, 542b, . . . 542d, which refer to the second side portions of respective display units 520a through 520d.

Continuing with FIGS. 11A and 11B, several display units 520 have a cross-sectional shape with primarily linear components. Display units 520a, 520d, and 520e can have linear side portions 540 and 542. Accordingly, display units 520a, 520d, and 520e and can be referred to as linear display units. Other display units have a cross-sectional shape with curved components. For instance, display units 520b and 520c have curved side portions 540 and 542. Thus, display units 520b and 520c can be referred to as curved display units. The display units can be arranged so that the first end 530a of the linear display unit 520a is disposed in close proximity to or abutting the second end 532b of the curved display unit 520b. The first end 530b of the curved display unit 520b is in close proximity to the second end 532c of the additional curved display unit 520c. The first end 530c of the curved display unit 520c is close proximity to the second end 532d of the linear display unit 520d. The auxiliary display unit 520e includes the POS system 50 is disposed in close proximity to or abutting the linear display unit 520d. Although each display unit 520a through 520e is shown having similar height, the heights of the units 520a through 520e can differ, as needed.

Turning to FIGS. 12A and 12B, in accordance with an alternative embodiment of the present disclosure, the system 610 includes a plurality of display units 620a, 620b, and 620c arranged to define a system with a generally triangular shape. The system 610 can have a base 612, an end 614 spaced from the base 612, and side portions 626 extend from the base 612 and converge toward the end 614. The system 610 extends along horizontal axis (not shown) that is parallel to the support surface (not shown). The first and second units 620a and 620b can connected together to define the base 612. A third unit 620c connected to the first and second units 520a and 520b define the end 614 of the system 610. While three units are shown, more than three units can be used to define the system 610. Further, one up to all of the units 620a, 620b, and 620c are configured to hold multiple containers 40. Each unit 620a, 620b, and 620c can have the same or different heights as discussed above.

Another embodiment of the present disclosure includes a method for merchandising bulk food items in a public establishment. The merchandising method can broadly include display bulk food items in the containers, the merchandising method can also include fabrication the components of the system for modularity so that the display units can quickly assembled and disassembled, and move around in the public establishment until the right location is obtained that can generate the most revenue. Thus, the method can include fabricating the system to include the plurality of display units as described above and illustrated in FIGS. 1-12B. The units can be fabricated using typical construction materials. For instance, the bottom, top 24, and sides 26 can each be formed into a desired shape. For instance, the bottom 22 can be constructed to match the inclination of the support surface 14, if any. The bottom 22 can be formed to be parallel to the top 24 or inclined with respect to the top 24. In other embodiments, the bottom 24 can be formed using one or more support posts. In still other embodiment, the lower portion of the sides can define the bottom 2 of the display unit such that forming the sides 26 also forms the bottom 22. The top 24 can shaped to match the support surface 14, and can be formed to be parallel to the bottom 22 or inclined with respect to the bottom 22. The sides 26 can constructed and formed according the particular design needed. For instance, the sides 26 can be formed into linear, flat panels or alternatively curved panels. The bottom 22, top 24 and sides 25 constructed of particle board, MDF, wood panels, aluminum, or polymeric materials. In certain embodiment, the bottom 22, top 24 and sides 25 are constructed of flame resistant panels. Flame resistance can be accomplished via coatings or finishes or use of flame resistant materials. The flame resistant panels can be rated to comply with regulations applicable to the particular public establishment or the specific locality where the display unit is located. In addition, each panel can include various laminate or coatings that can be used to apply different coloring schemes to the units. Further, various permanent or quick release connectors can be affixed to or formed into the bottom 22, top 24, and sides 26 to facilitate assembly of the system in the public establishment. The bottom, top 24 and sides 26 can be assembled to define a display unit. In other embodiments, the components of each display unit can be formed, connectors attached thereto, and packaged into kits for transport to the public establishment 12 for assembly on-site. The method can include assembling the system 10 by arranging the display units along a plane that is parallel to the support surface. In addition, the method includes the step of installing a point-of-sale system. The assembly step can occur in less than about 8 to 10 hours. The method can include the step of removing the plurality of display units from the support surface in less than about 8 to 10 hours. The method includes displaying, during assembly, placing the containers in the respective openings and then filling the containers with a different bulk food item. A consumer/user can select desired bulk item. The amount of payment for the selected bulk food items collected can be determined via the POS system 50. In one embodiment, the amount of payment is based on the weight of the bulk food item. The method thus includes receiving payment for an amount of bulk food item collected from one or more of the plurality of containers.

Another embodiment of the present disclosure is a retail building that includes one or systems as described above and illustrated in FIGS. 1-12B. Such a system includes a plurality of display units, each unit having a top and a bottom, with the top holding a plurality of containers that store bulk food items. The display units can be arranged along a plane parallel to the support surface such that the plane P extends through a lower portion of each display unit. The system can be disposed along one or more pedestrian thoroughfares. A POS system can be used to receive payment for items selected from the bulk food items.

While the disclosure is described herein using a limited number of embodiments, these specific embodiments are not intended to limit the scope of the disclosure as otherwise described and claimed herein. Modification and variations from the described embodiments exist. More specifically, the following examples are given as a specific illustration of embodiments of the claimed disclosure. It should be understood that the invention is not limited to the specific details set forth in the examples.

What is claimed:

1. A system for displaying bulk food items for sale in a public establishment, the system comprising:
a plurality of display units configured to be positioned on a support surface at the public establishment such that the plurality of display units are aligned along a plane that is parallel to the support surface, each unit including a bottom supportable by the support surface, a top spaced from the bottom, and a side that extends between the top and the bottom; and
a plurality of containers supported by the top of at least one of the plurality of display units, each container configured to hold bulk food items, the container including an opening sized to permit removal of the bulk food items from the container.

2. The system of claim 1, wherein when the plurality of display units are positioned on the support surface, the top of at least one of the plurality of display units defines a first height above the support surface and the top of another one of the plurality of display units defines a second height above the support surface that is less than the first height.

3. The system of claim 1, wherein the plurality of display units is at least a first display unit, a second unit, and a third unit, wherein a first portion of the side of the first display unit is positioned in proximity to the second unit along a first axis, and a second portion of the side of the first display unit is positioned in proximity to the third unit along a second axis that is angularly offset with respect to the first axis.

4. The system of claim 3, wherein the side of the first display unit abuts the respective sides of the second unit and the third unit.

5. The system of claim 3, wherein the side of the first display unit is spaced apart from the respective sides of the second unit and the third unit.

6. The system of claim 1, wherein when the plurality of display units are positioned on the support surface, the plurality of display units cover between up to about 500 square feet of the support surface.

7. The system of claim 1, wherein when the plurality of display units are positioned on the support surface, the plurality of display units cover between about 50 square feet and about 300 square feet of the support surface.

8. The system of claim 1, wherein each unit defines a respective unit height that extends from the bottom of the unit to the top of the unit, wherein the unit height is between about 10 inches and 45 inches.

9. The system of claim 1, further comprising a point-of-sale system.

10. The system of claim 1, wherein one or more of the plurality of containers are transparent.

11. The system of claim 10, wherein the one or more of the plurality of containers have a curved profile.

12. The system of claim 11, wherein top includes a plurality of openings, the plurality of openings sized to receive a portion of the respective plurality of containers.

13. The system of claim 10, wherein the containers are aligned in multiple rows along the top of the unit.

14. The system of claim 1, wherein each unit defines a vertical axis that extends through the top and the bottom, each unit defining a cross-sectional shape that is perpendicular to the vertical axis, the cross-sectional shape having a linear component.

15. The system of claim 1, wherein each unit defines a vertical axis that extends through the top and the bottom, each unit defining a cross-sectional shape that is perpendicular to the vertical axis, the cross-sectional shape having a curvilinear component.

16. The system of claim 1, wherein the plurality of display units are configured to be assembled on the support surface in less than 8 hours.

17. The system of claim 16, wherein the plurality of display units are configured to be disassembled and removed from the support surface in less than 8 hours.

18. A method for merchandising bulk food items in a public establishment, the method including:
positioning a plurality of display units along a support surface of a public establishment such that the plurality of display units are aligned along a plane that is parallel to the support surface, each unit including a bottom, a top spaced from the bottom, a plurality of transparent containers supported by the top, and a height that extends from the support surface to the top, wherein the height of a first one of the plurality of display units is greater than a second one of the plurality of display units;
displaying in each container a respective bulk food item; and
receiving a payment for an amount bulk food item collected from one or more of the plurality of containers.

19. The method of claim 18, further comprising the step of fabricating each unit.

20. The method of claim 19, wherein the fabricating step include forming the components for each unit, the components including at least the top and side of each unit.

21. The method of claim 19, further comprising the step transporting each unit to a public establishment for assembly of the system along the support surface.

22. The method of claim 20, further comprising the step of transporting each component of the unit to the public establishment.

23. The method of claim 22, further comprising the step of assembling each unit on the support surface.

24. The method of claim 18, further comprising the step of installing a point-of-sale system.

25. The method of claim 18, wherein the step of positioning the plurality of display units on the support surface occurs in less than 8 hours.

26. The method of claim 18, further comprising the step of removing the plurality of display units from the support surface in less than 8 hours.

27. The method of claim 18, further comprising the step of determining the amount of the payment based on a weight of the bulk food items collected.

28. The method of claim 17, further comprising the step of determining the amount of the payment based on a volume of the bulk food items collected.

29. The method of claim 18, further comprising the step of moving the system from one location in the public establishment to another location in the public establishment.
